(19) United States
(12) Patent Application Publication
(10) Pub. No.: US 2013/0250639 A1
(43) Pub. Date: Sep. 26, 2013

(54) DIGITAL CONTROLLED POWER CONVERTER WITH EMBEDDED MICROCONTROLLER

(71) Applicant: SYSTEM GENERAL CORPORATION, New Taipei City (TW)

(72) Inventors: Ta-Yung YANG, Milpitas, CA (US); Yi-Min HSU, Taichung City (TW); Chung-Hui YEH, New Taipei City (TW); Pei-Sheng TSU, New Taipei City (TW)

(73) Assignee: SYSTEM GENERAL CORPORATION, New Taipei City (TW)

(21) Appl. No.: 13/850,636

(22) Filed: Mar. 26, 2013

Related U.S. Application Data
(60) Provisional application No. 61/615,363, filed on Mar. 26, 2012.

(51) Int. Cl. H02M 7/06

(52) U.S. Cl. CPC H02M 7/06
USPC 363/126

(57) ABSTRACT

The present invention provides a digital controller for a power converter. The digital controller includes a microcontroller, an analog-to-digital converter, a signal generator, a protection circuit, and a PWM circuit. The analog-to-digital converter is coupled to an output of the power converter for generating a digital feedback signal for the microcontroller. The signal generator is controlled by the microcontroller for generating a switching signal coupled to switch a transformer. The protection circuit generates a reset signal to disable the switching signal. The microcontroller controls the switching signal to regulate the output of the power converter. The protection circuit is further coupled to detect a switching current of the transformer for controlling the reset signal if the switching current of the transformer exceeds a second threshold. The PWM circuit generates a PWM signal coupled to control a synchronous rectifying transistor for synchronous rectifying operation.

### CROSS REFERENCE TO RELATED APPLICATIONS

This application claims the benefit of U.S. Provisional Application No. 61/615,363, filed on Mar. 26, 2012, the contents of which are incorporated herein by reference.

### BACKGROUND OF THE INVENTION

1. Field of the Invention

The present invention relates to power converters, more specifically, the present invention relates to digital controlled power converters.

2. Description of the Related Art

Recently, digital controlled power converters have been developed for providing more precise and building in some smart functions by programming the microcontroller with memory inside their controller chip. However, some disadvantages still exist, such as the bandwidth limit to sample the analog signals, sampling noises and the calculating delay limited by the operation clock of the microcontrollers. Therefore, a design to reducing the loading of the microcontroller of the digital controlled power converters with lower costs is desired by the industries.

### BRIEF SUMMARY OF THE INVENTION

The present invention provides an exemplary embodiment of a digital control circuit for a power converter. The digital control circuit comprises a microcontroller, an analog-to-digital converter, a signal generator, a PWM circuit, and a sensing circuit. The microcontroller has a memory circuit. The analog-to-digital converter is coupled to an output of the power converter for generating a digital feedback signal for the microcontroller. The signal generator is controlled by the microcontroller for generating a switching signal coupled to switch a transformer. The microcontroller controls a frequency of the switching signal to regulate the output of the power converter. A pulse width of the switching signal is further controlled by the microcontroller for regulating the output of the power converter. The PWM circuit generates a PWM signal coupled to control a synchronous rectifying transistor for a synchronous rectifying operation. The PWM circuit is controlled by the microcontroller. The sensing circuit is coupled to an output rectifier for detecting an on/off state of the output rectifier and generating a detection signal. The output rectifier is a rectifier or a body diode of the synchronous rectifying transistor. The detection signal is coupled to enable the PWM signal. The PWM circuit comprises a synchronous-rectifying timer. The synchronous-rectifying timer records a synchronous-rectifying margin period. The synchronous-rectifying margin period starts from the synchronous rectifying transistor being turned off to the output rectifier being turned off The microcontroller reads the synchronous-rectifying margin period. The analog-to-digital converter is further coupled to detect a switching current of the transformer. The switching signal will generate an interrupting signal coupled to interrupt the microcontroller.

The present invention also provides an exemplary embodiment of a digital controller for a power converter. The digital controller comprises a microcontroller, an analog-to-digital converter, a signal generator, a protection circuit, and a PWM circuit. The microcontroller has a memory circuit. The analog-to-digital converter is coupled to an output of the power converter for generating a digital feedback signal for the microcontroller. The signal generator is controlled by the microcontroller for generating a switching signal coupled to switch a transformer. The protection circuit generates a reset signal to disable the switching signal. The microcontroller controls the switching signal to regulate the output of the power converter. The protection circuit is coupled to the output of the power converter for generating the reset signal if the output of the power converter exceeds a first threshold. The protection circuit further comprises a watchdog timer for generating the reset signal to disable the switching signal if the watchdog timer is running overflowed. The protection circuit is further coupled to detect a switching current of the transformer for controlling the reset signal if the switching current of the transformer exceeds a second threshold. The analog-to-digital converter is further coupled to detect the switching current of the transformer. The PWM circuit generates a PWM signal coupled to control a synchronous rectifying transistor for a synchronous rectifying operation. The PWM circuit is controlled by the microcontroller. The reset signal is coupled to disable the PWM signal. A disabled state of the switching signal is reset by the microcontroller.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a power converter according to an embodiment of the present invention;

FIG. 2A shows the waveforms of a first switching signal and a second switching signal;

FIG. 2B shows the waveforms of the first switching signal, the second switching signal, a first detection signal and a first synchronous rectifying signal;

FIG. 3 shows an embodiment of a controller of the power converter according to the present invention;

FIG. 4 shows an embodiment of a signal generator of the controller according to the present invention;

FIG. 5 shows an embodiment of a PWM circuit of the controller according to the present invention;

FIG. 6 shows an embodiment of a PWM signal generator of the PWM circuit according to the present invention;

FIG. 7 shows an embodiment of a protection circuit of the controller according to the present invention;

FIG. 8 shows an embodiment of a signal detection circuit of the controller according to the present invention; and

FIG. 9 shows the waveforms of the first switching signals, the second switching signal and a switching current.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

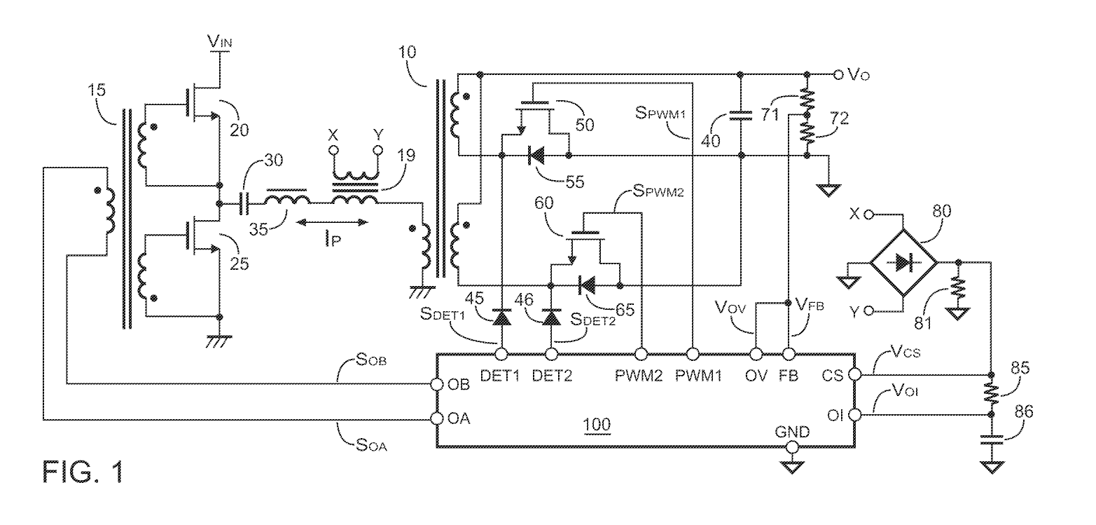

FIG. 1 shows a power converter according to an embodiment of the present invention. Transistors 20 and 25 switch the transformer 10 through a capacitor 30 and a inductor 35. The capacitor 30 and the inductor 35 develop a resonant tank. The inductor 35 can be a part of the transformer 10, such as the leakage inductance of the transformer 10. Secondary windings of the transformer 10 generate the output voltage V_{O} across a capacitor 40 via output rectifiers 55 and 65. Transistors (also referred to as synchronous rectifying transistors) 50 and 60 are connected to the output rectifier 55 and 65 respectively for the synchronous rectifying. The output rectifiers 55 and 65 can be the body diode of the transistors 50 and 60 respectively. A voltage divider formed by resistors 71 and 72 divides the output voltage V_{O} to generate a feedback signal V_{FB} coupled to a feedback terminal FB of a controller 100. In response to the feedback signal V_{FB}, the controller 100 generates a first switching signal S_{OA} and a second switching signal S_{OB} at terminals OA and OB respectively. The switching signals S_{OA} and S_{OB} are coupled to control transistors 20 and 30 via a driver transformer 15 respectively. The frequency of the switching signals S_{OA} and S_{OB} will determine the output power of the resonant power converter.

A diode 45 is connected to the output rectifier 55 for generating a first detection signal S_{DET1} to a first detection terminal DET1 of the controller 100. A diode 46 is connected to the output rectifier 65 for generating a second detection signal S_{DET2} to a second detection terminal DET2 of the controller 100. The diode 45 and the diode 46 serve as sensing circuits. When the transistor 50 is turned off, a pulled-low state of the first detection signal S_{DET1} indicates the output rectifier 55 is still turned on. According to the state of the switching signals S_{OA} and S_{OB} and/or the detection signals S_{DET1} and S_{DET2}, the controller 100 generates a first synchronous-rectifying signal S_{PWM1} and a second synchronous-rectifying signal S_{PWM2} from its first driving terminal PWM1 and second driving terminal PWM2 respectively to control the transistors 50 and 60 respectively for synchronous rectifying operation.

A current transformer 19 is coupled to the transformer 10 for detecting a switching current I_{P} of the transformer 10 and generates a current signal V_{CS} via a high speed bridge-rectifier 80 and a resistor 81. Via a resistor 85 and a capacitor 86, the current signal V_{CS} further generates an average-current signal V_{OI} for over-current protection. The current signal V_{CS} and the average-current signal V_{OI} are received by the controller 100 at its current terminal CS and current protection terminal OI, respectively. A signal V_{OV} is further coupled to the controller 100 at its voltage protection terminal OV for the over-voltage protection. Since the voltage protection terminal OV and the feedback terminal FB of the controller 100 are connected together in this embodiment, the level of the signal V_{OV} and the level of the feedback voltage V_{FB} will be correlated to the level of the output voltage V_{O}.

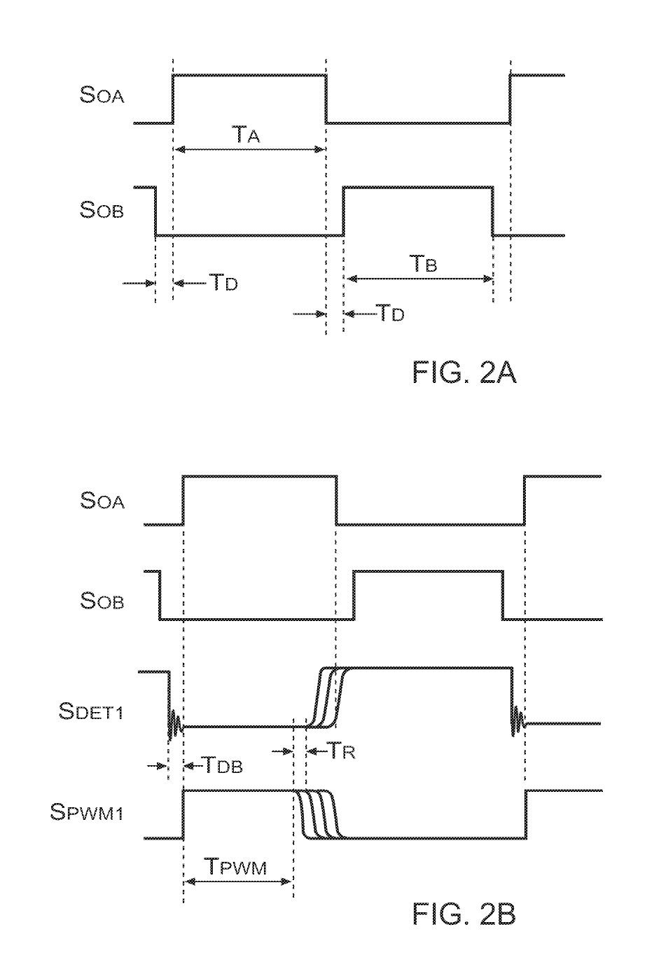

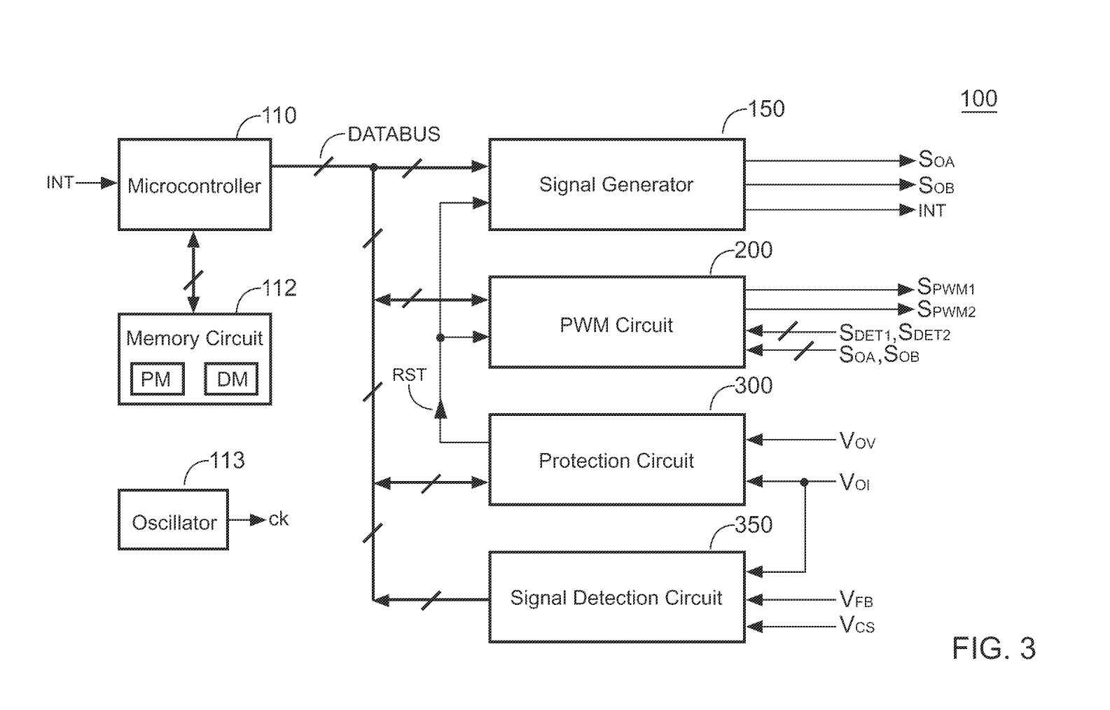

FIG. 2A shows the waveforms of the switching signals S_{OA} and S_{OB}. The on-time of the first switching signal S_{OA} is T_{A}. The on-time of the second switching signal S_{OB} is T_{B}. A dead-time T_{D} exists between the switching signals S_{OA} and S_{OB}. The timing of the T_{A}, T_{B}, and T_{D} is programmable by timers. Therefore, the frequency, the duty-cycle and the pulse width of the switching signals S_{OA} and S_{OB} are programmable.

FIG. 2B shows the waveforms of the switching signals S_{OA} and S_{OB}, the first detection signals S_{DET1}, and the first synchronous-rectifying signal S_{PWM1}. When the first switching signal S_{OA} is “pulled-high” and/or the first detection signal S_{DET1} is “pulled-low”, then the first synchronous-rectifying signal S_{PWM1} will be generated to turn on the transistor 50 for the synchronous rectifying. A de-bounce time T_{DB} ensures the first detection signal S_{DET1} has been pulled low. The pulse width T_{PWM} of the first synchronous-rectifying signal S_{PWM1} is programmed by a timer. Another timer will record the timing T_{R} that starts from the time the first synchronous-rectifying signal S_{PWM1} is disabled to the time the first detection signal S_{DET1} is pulled high. It means the timing T_{R} records the period from the time the transistor 50 is turned off to the time the period the output rectifier 55 is turned off. The timing T_{R} is utilized to program the pulse width T_{PWM} for optimizing the synchronous rectifying.

FIG. 3 shows an embodiment of the controller 100 of the power converter according to the present invention. The controller 100 includes a microcontroller 110 with its memory circuit 112 including a program memory PM and a data memory DM. An oscillation circuit 113 generates a clock signal ck. Through the data bus DATABUS, the microcontroller 110 controls a signal generator 150 to generate the switching signals S_{OA} and S_{OB} and an interrupting signal INT. The pulse width of the switching signals S_{OA} and S_{OB} is controlled by the microcontroller 110 for regulating the output of the power converter. The interrupting signal INT is coupled to interrupt the microcontroller 110 in response to the falling edge of the switching signals S_{OA} and S_{OB}. A PWM circuit 200 is coupled to generate synchronous rectifying signals S_{PWM1} and S_{PWM2} in response to the switching signals S_{OA} and S_{OB} and/or the detection signals S_{DET1} and S_{DET2}. The pulse widths of synchronous rectifying signals S_{PWM1} and S_{PWM2} is programmed by the microcontroller 110. A protection circuit 300 generates a reset signal RST coupled to disable the switching signals S_{OA} and S_{OB} and the synchronous rectifying signals S_{PWM1} and S_{PWM2} when the signal V_{OV} exceeds a threshold, the average-current signal V_{OI} exceeds another threshold, or a watchdog timer becomes overflow. A signal detection circuit 350 (referred to as an analog-to-digital converter) is coupled to convert the feedback signal V_{FB}, the current signal V_{CS} and the average-current signal V_{OI} into digital data for the microcontroller 110 via the data bus DATABUS.

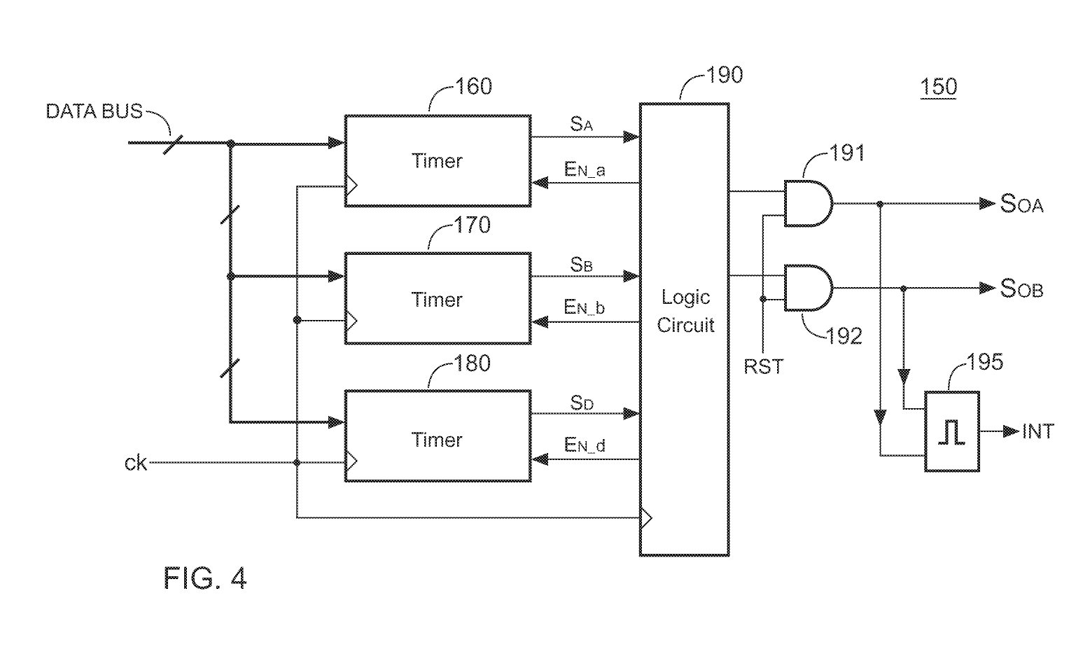

FIG. 4 shows an embodiment of the signal generator 150 of the controller 100 according to the present invention. The signal generator 150 includes timers 160, 170, and 180, a logic circuit 190, AND gates 191 and 192, and a pulse generation circuit 195. The timer 160 determines the on-time T_{A} of the first switching signal S_{OA} (shown in FIG. 2A). The timer 170 determines the on-time T_{B} of the second switching signal S_{OB}. The timer 180 determines the dead-time T_{D}. In one embodiment of the present invention, the timers 160 and 170 are 16-bit length timers, and the timer 180 is an 8-bit length timer. Those aforementioned timers can be programmed via the data bus DATABUS. The output S_{A} of the timer 160, the output S_{B} of the timer 170, and the output S_{D} of the timer 180 are coupled to the logic circuit 190 to generate the switching signals S_{OA} and S_{OB} via the AND gates 191 and 192, respectively. The logic circuit 190 further generates enabling signals E_{N}_{_{—}}ₐ, E_{N}_{_{—}}_{b}, and E_{N}_{_{—}}_{d} to enable the timers 160, 170 and 180, respectively. The reset signal RST is also connected to the AND gates 191 and 192. The falling edge of the switching signals S_{OA} and S_{OB} will activate the interrupting signal INT via the pulse generation circuit 195.

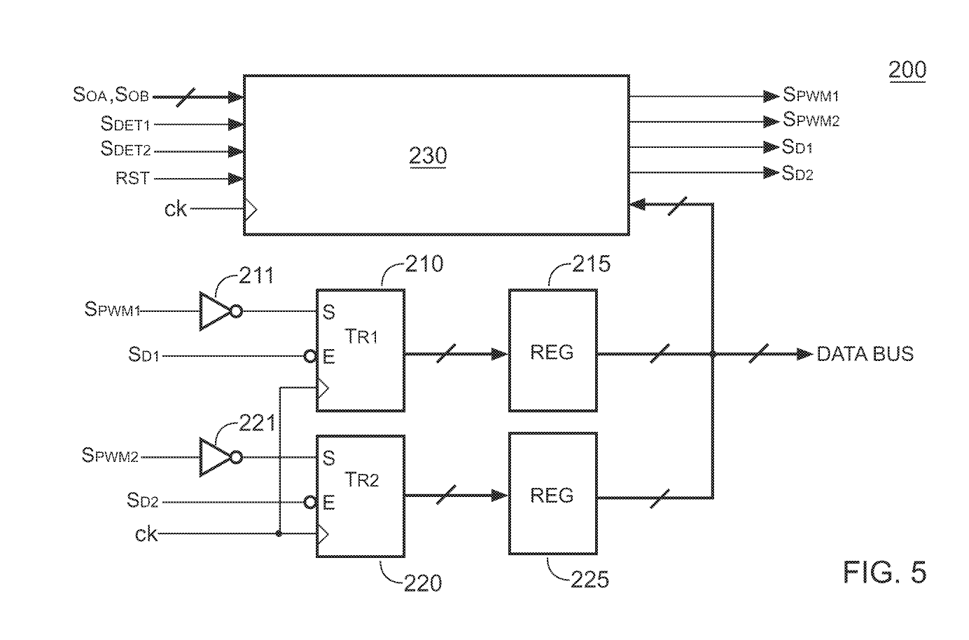

FIG. 5 shows an embodiment of the PWM circuit 200 of the controller 100 according to the present invention. The PWM circuit 200 includes a PWM signal generator 230 for generating the synchronous rectifying signals S_{PWM1} and S_{PWM2} in response to the switching signals S_{OA} and S_{OB} and/or the detection signals S_{DET1} and S_{DET2}. The PWM signal generator 230 also generates trigger signals S_{D1} and S_{D2}. The trigger signals S_{D1} and S_{D2} are correlated to the detection signals S_{DET1} and S_{DET2}. The synchronous rectifying signals S_{PWM1} is applied to a terminal S of a synchronous-rectifying timer (T_{R1}) 210 through an inverter 211, and the trigger signals S_{D1} is supplied to a terminal E of the inverter 211. The synchronous rectifying signals S_{PWM2} is applied to a terminal S of a synchronous-rectifying timer (T_{R2}) 220 through an inverter 221, and the trigger signals S_{D2} is supplied to a terminal E of the inverter 212. The synchronous-rectifying timer 210 is utilized to record a synchronous-rectifying margin period (timing) T_{R} (shown in FIG. 2B) from “the disabling of the first synchronous-rectifying signal S_{PWM1}” to “the logic-low of the trigger signal S_{D1} (that is the first detection signal S_{DET1} being pulled high)”. The synchronous-rectifying timer 220 is utilized to record the synchronous-rectifying margin period (timing) T_{R} (shown in FIG. 2B) from “the disabling of the second synchronous-rectifying signal S_{PWM2}” to “the logic-low of the trigger signal S_{D2} (the second detection signal S_{DET2} being pulled high)”. The data of the synchronous-rectifying timers 210 and 220 are stored into registers (REG) 215 and 225 respectively. The microcontroller 110 can therefore read the data stored in the registers 215 and 225 to get the margin period data of the synchronous-rectifying timers 210 and 220 through the data bus DATABUS.

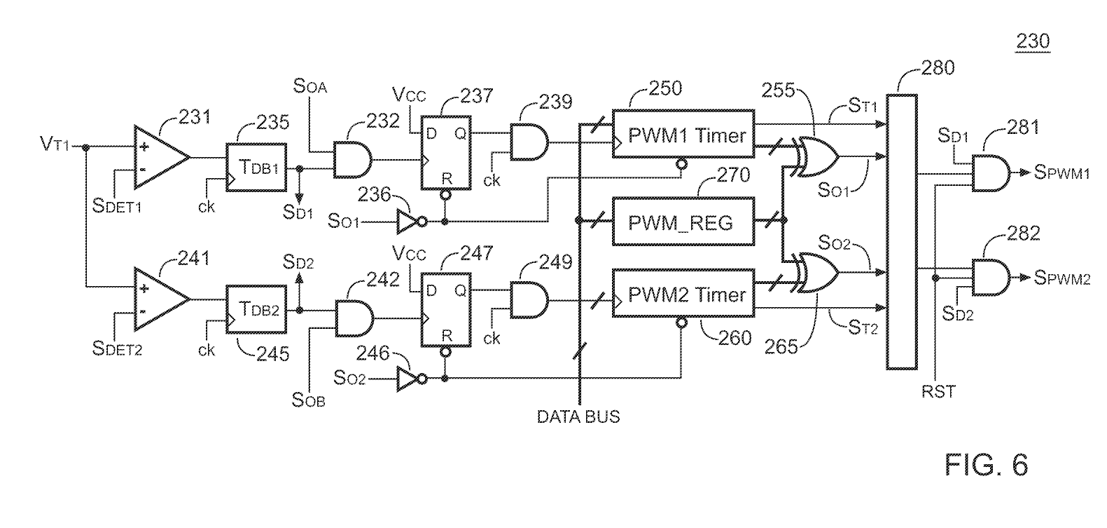

FIG. 6 shows an embodiment of the PWM signal generator 230 of the PWM circuit 200 according to the present invention. The PWM signal generator 230 includes a comparator 231 coupled to receive the first detection signal S_{DET1}. The comparator 231 will generate an output coupled to a de-bounce circuit (T_{DB1}) 235 once the first detection signal S_{DET1} is higher or lower than a threshold V_{T1}. The de-bounce circuit 235 will output the trigger signal S_{D1}. The trigger signal S_{D1} and the first switching signal S_{OA} are coupled to inputs of an AND gate 232. An output of the AND gate 232 is coupled to a flip-flop 237. The output of the flip-flop 237 and the clock signal ck are coupled to inputs of an AND gate 239. An output of the AND gate 239 is applied to control a clock input of a timer (PWM1 Timer) 250. The value of the timer 250 is programmed by the microcontroller 110 through the data bus DATABUS.

A comparator 241 is coupled to receive the second detection signal S_{DET2}. The comparator 241 will generate an output coupled to a de-bounce circuit (T_{DB2}) 245 once the second detection signal S_{DET2} is higher or lower than the threshold V_{T1}. The de-bounce circuit 245 will output the trigger signal S_{D2}. The trigger signal S_{D2} and the second switching signal S_{OB} are coupled to inputs of an AND gate 242. An output of the AND gate 242 is coupled to a flip-flop 247. The output of the flip-flop 247 and the clock signal ck are coupled to inputs of an AND gate 249. An output of the AND gate 249 is applied to control a clock input of a timer (PWM2 Timer) 260. The value of the timer 260 is programmed by the microcontroller 110 through the data bus DATABUS.

The data of a register (PWM_REG) 270 is programmed by the microcontroller 110 via the data bus DATABUS. When the clock signal ck is enabled for clocking the timer 250, a start signal S_{T1} will be generated. A digital comparator 255 is coupled to compare the value of the timer 250 and the value of the register 270. Once the value of the timer 250 and the value of the register 270 are equal, the digital comparator 255 will generate a stop signal S_{OI}. Through an inverter 236, the stop signal S_{OI} is coupled to reset the flip-flop 237 and stop the clock signal ck being sent into the timer 250. Both the start signal S_{T1} and the stop signal S_{OI} are coupled to generate the first synchronous-rectifying signal S_{PWM1} through a logic circuit 280 and an AND gate 281.

When the clock signal ck is enabled for clocking the timer 260, a start signal S_{T2} will be generated. A digital comparator 265 will be coupled to compare the value of the timer 260 and the value of register 270. Once the value of the timer 260 and the value of register 270 are equal, the digital comparator 265 will generate a stop signal S_{O2}. Through an inverter 246, the stop signal S_{O2} is coupled to reset the flip-flop 247 and stop the clock signal ck be sent to the timer 260. Both the start signal S_{T2} and the stop signal S_{O2} are coupled to generate the second synchronous-rectifying signal S_{PWM2} through the logic circuit 280 and an AND gate 282. The reset signal RST is coupled to the AND gates 281 and 281 to disable synchronous rectifying signals S_{PWM1} and S_{PWM2} once the reset signal RST is enabled for the protection.

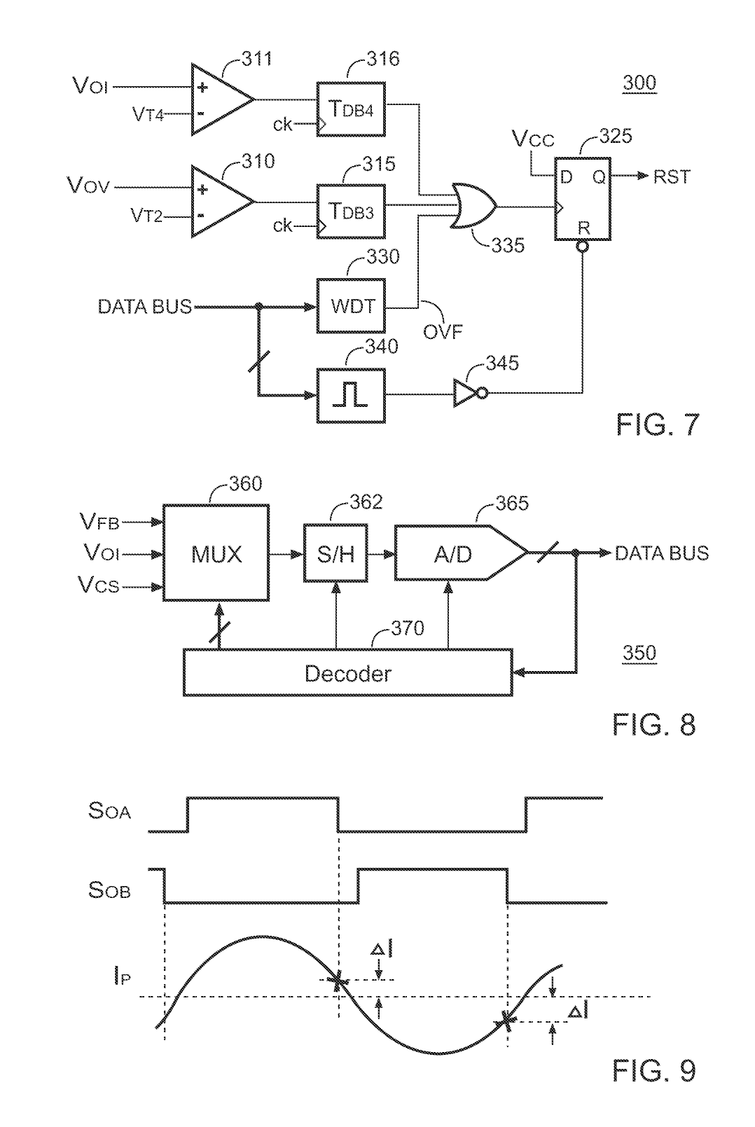

FIG. 7 shows an embodiment of the protection circuit 300 of the controller 100 according to the present invention. The protection circuit 300 can receive the average-current signal V_{OI} for detecting the switching current I_{P}. A comparator 310 is coupled to receive the signal V_{OV}, and generate an output signal to a de-bounce circuit (T_{DB3}) 315 when the signal V_{OV} exceeds a threshold V_{T2}. A comparator 311 is coupled to receive the average-current signal V_{OI}, and generate an output signal to a de-bounce circuit (T_{B4}) 316 when the average-current signal V_{OI} exceeds a threshold V_{T4}. The output of the de-bounce circuits 315 and 316 are coupled to a flip-flop 325 via an OR gate 335 for generating the reset signal RST. Another input of the OR gate 335 receives an overflow signal OVF from a watchdog timer (WDT) 330 whenever the watchdog timer is running overflowed. The watchdog timer 330 is controlled by the microcontroller 110 though the data bus DATABUS. When the protection is activated by the signal V_{OV} or the watchdog timer 330, the protection state and the reset signal RST will be latched by the flip-flop 325. Only the microcontroller 110 can reset the flip-flop 325 via the data bus DATABUS, a decoder 340, and an inverter 345.

FIG. 8 shows an embodiment of the signal detection circuit 350 of the controller 100 according to the present invention. A decoder 370 is coupled to the data bus DATABUS for generating the signals to control a multiplexer (MUX) 360, a sample-and-hold circuit (S/H) 362 and an analog-to-digital converter (A/D) 365. The microcontroller 110 can read the output of the analog-to-digital converter 365 via the data bus DATABUS. The multiplexer 360 is coupled to receive the feedback signal V_{FB}, the average-current signal V_{OI}, and the current signal V_{CS}. Therefore, the microcontroller 110 can read the information of the feedback signal V_{FB} (digital feedback data), the average-current signal V_{OI}, and the current signal V_{CS}.

FIG. 9 shows the waveforms of the switching signals S_{OA} and S_{OB} and the switching current I_{P}. The switching current I_{P} is the current flows through the transformer 10 and the current transformer 19. The switching current I_{P} can be converted to the current signal V_{CS}. Thus, the signal detection circuit 350 can receive the current signal V_{CS} for detecting the switching current I_{P}. By measuring the current signal V_{CS} (through the signal detection circuit 350) in response to the interrupting signal INT (at the falling edge of the switching signals S_{OA} and S_{OB}), the microcontroller 110 can detect the signal level of ΔI. The signal level of ΔI indicates the margin of the switching current I_{P} before it falls to zero current. The level of ΔI is utilized to ensure the switching of the transistors 20 and 30 achieving ZVS (zero voltage switching). It also can make sure the resonant switching can be operated in inductive-mode. The level of ΔI also indicates the lowest switching frequency that is allowed for controlling the resonant power converter.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A digital control circuit for a power converter, comprising:
a microcontroller, having a memory circuit;
an analog-to-digital converter, coupled to an output of said power converter for generating a digital feedback signal for said microcontroller; and
a signal generator, controlled by said microcontroller for generating a switching signal coupled to switch a transformer, wherein said microcontroller controls a frequency of said switching signal to regulate said output of said power converter;

2. The digital control circuit as claimed in claim 1, wherein a pulse width of said switching signal is further controlled by said microcontroller for regulating said output of said power converter.

3. The digital control circuit as claimed in claim 1, further comprising
a PWM circuit for generating a PWM signal coupled to control a synchronous rectifying transistor for a synchronous rectifying operation, wherein said PWM circuit is controlled by said microcontroller.

4. The digital control circuit as claimed in claim 3, further comprising:
a sensing circuit coupled to an output rectifier for detecting an on/off state of said output rectifier and generating a detection signal, wherein said output rectifier is a rectifier or a body diode of said synchronous rectifying transistor, and said detection signal is coupled to enable said PWM signal.

5. The digital control circuit as claimed in claim 3, wherein said PWM circuit comprises:
a synchronous-rectifying timer for recording a synchronous-rectifying margin
wherein said synchronous-rectifying margin period starts from said synchronous rectifying transistor being turned off to said output rectifier being turned off, and said microcontroller reads said synchronous-rectifying margin period.

6. The digital control circuit as claimed in claim 1, wherein said analog-to-digital converter is further coupled to detect a switching current of said transformer.

7. The digital control circuit as claimed in claim 1, wherein said switching signal generates an interrupting signal coupled to interrupt said microcontroller.

8. A digital controller for a power converter, comprising:
a microcontroller, having a memory circuit;
an analog-to-digital converter, coupled to an output of said power converter for generating a digital feedback signal for said microcontroller;
a signal generator, controlled by said microcontroller for generating a switching signal coupled to switch a transformer; and
a protection circuit, for generating a reset signal to disable said switching signal,
wherein said microcontroller controls said switching signal to regulate said output of said power converter, and said protection circuit is coupled to said output of said power converter for generating said reset signal if said output of said power converter exceeds a first threshold.

9. The digital controller as claimed in claim 8, wherein said protection circuit further comprises:
a watchdog timer for generating said reset signal to disable said switching signal if said watchdog timer is running overflowed.

10. The digital controller as claimed in claim 8, wherein said protection circuit is further coupled to detect a switching current of said transformer for controlling said reset signal if said switching current of said transformer exceeds a second threshold.

11. The digital controller as claimed in claim 10, wherein said analog-to-digital converter is further coupled to detect said switching current of said transformer.

12. The digital controller as claimed in claim 8, further comprising:
a PWM circuit for generating a PWM signal coupled to control a synchronous rectifying transistor for a synchronous rectifying operation, wherein said PWM circuit is controlled by said microcontroller.

13. The digital controller as claimed in claim 11, wherein said reset signal is coupled to disable said PWM signal.

14. The digital controller as claimed in claim 12, wherein a disabled state of said switching signal is reset by said microcontroller.
